(19) United States
(12) Patent Application Publication
(10) Pub. No.: US 2016/0094442 A1
(43) Pub. Date: Mar. 31, 2016

(54) PROTOCOL INDEPENDENT MULTICAST (PIM) REGISTER MESSAGE TRANSMISSION

(71) Applicant: LENOVO ENTERPRISE SOLUTIONS (SINGAPORE) PTE. LTD., New Tech Park (SG)

(72) Inventors: Sivakumar Arumugam, Milpitas, CA (US); Chidambaram Bhagavathiperumal, Santa Clara, CA (US); Solomon Coriiu, Bucharest (RO); Angu S. Chandra Sekaran, Santa Clara, CA (US); Ashok K.M. Somosundaram, Santa Clara, CA (US)

(21) Appl. No.: 14/498,013

(22) Filed: Sep. 26, 2014

(51) Int. Cl. H04L 12/721; H04L 12/931; H04L 12/18

(52) U.S. Cl. CPC H04L 45/72; H04L 12/18; H04L 49/70; H04L 41/0654

(57) ABSTRACT

Embodiments of the invention relate to register message transmission control in a system. One embodiment includes forwarding a communication packet to a first switch. A multicast source route entry is created by the first switch based on the communication packet. The communication packet is forwarded from the first switch to a second switch. A duplicate of the multicast source route entry is created by the second switch based on the forwarded communication packet. A register message is sent to a router by one of the first switch and the second switch based on a first vLAG role. Sending of a duplicate of the register message by one of the first switch and the second switch is prevented based on a second vLAG role.

### BACKGROUND

The present invention relates to network switches and switching, and more particularly, this invention relates to protocol independent multicast (PIM) multicast register message transmission control in a virtual link aggregation group (vLAG) topology.

In a data center comprising one or more access switches, each access switch connects two aggregation switches for redundancy. Link aggregation uses available bandwidth across a switch boundary at an aggregation layer.

### BRIEF SUMMARY

Embodiments of the invention relate to register message transmission control in a system. One embodiment includes forwarding a communication packet to a first switch. A multicast source route entry is created by the first switch based on the communication packet. The communication packet is forwarded from the first switch to a second switch. A duplicate of the multicast source route entry is created by the second switch based on the forwarded communication packet. A register message is sent to a router by one of the first switch and the second switch based on a first vLAG role. Sending of a duplicate of the register message by one of the first switch and the second switch is prevented based on a second vLAG role.

Another embodiment comprises a system including an access switch that receives a communication packet from a multicast source. A first vLAG switch receives the communication packet from the access switch and extracts a multicast source route entry from the received communication packet. A second vLAG switch receives the communication packet from the first vLAG switch and extracts the multicast source route entry from the received communication packet. One of the first vLAG switch and the second vLAG switch sends a register message to a router based on vLAG roles. One of the first vLAG switch and the second vLAG switch is prevented from sending a duplicate of the register message to the router based on a particular vLAG role.

One embodiment comprises a computer program product for register message transmission control over a link aggregation group (LAG). The computer program product comprising a computer readable storage medium having program instructions embodied therewith. The computer readable storage medium is not a transitory signal per se. The program instructions executable by an access switch to cause the access switch to perform a method comprising: forwarding, by the access switch, a communication packet to a first virtual link aggregation group (vLAG) switch. The first vLAG switch creates a multicast source route entry based on the communication packet. The first vLAG switch forwards the communication packet to a second vLAG switch. The second vLAG switch creates a duplicate of the multicast source route entry based on the forwarded communication packet. A register message is sent to a router by one of the first vLAG switch and the second vLAG switch based on vLAG roles. Sending of a duplicate of the register message by one of the first vLAG switch and the second vLAG switch is prevented based on a particular vLAG role.

Other aspects and embodiments of the present invention will become apparent from the following detailed description, which, when taken in conjunction with the drawings, illustrate by way of example the principles of the invention.

### BRIEF DESCRIPTION OF THE SEVERAL VIEWS OF THE DRAWINGS

FIG. 1 is a network architecture, in accordance with one embodiment of the invention;

FIG. 2 shows a representative hardware environment that may be associated with the servers and/or clients of FIG. 1, in accordance with one embodiment of the invention;

FIG. 3 is a diagram of an example data center system, in which an embodiment of the invention may be implemented; and

FIG. 4 is a block diagram showing another process, in accordance with an embodiment of the invention.

### DETAILED DESCRIPTION

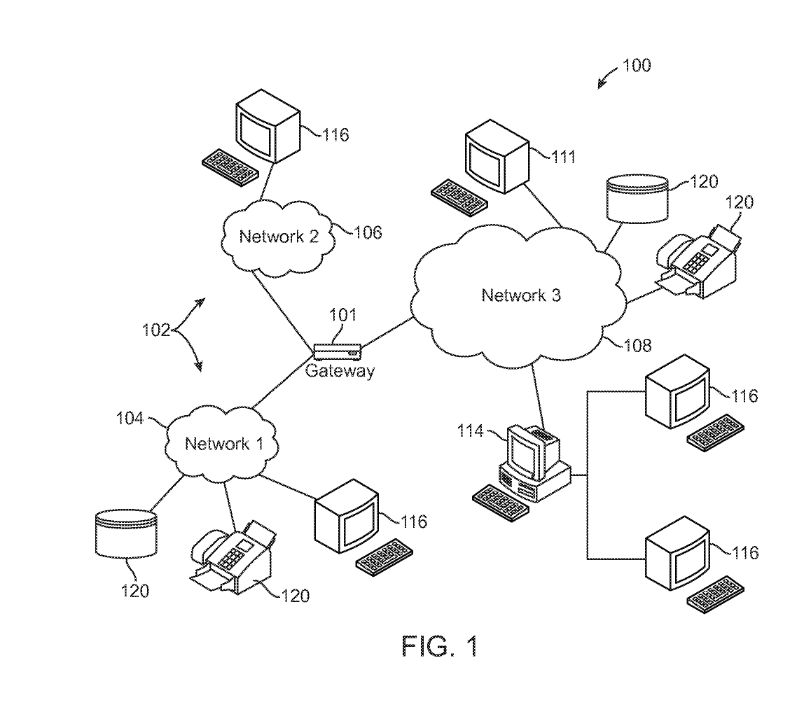

Referring now to the drawings, FIG. 1 illustrates a network architecture 100, in accordance with one embodiment. As shown in FIG. 1, a plurality of remote networks 102 are provided, including a first remote network 104 and a second remote network 106. A gateway 101 may be coupled between the remote networks 102 and a proximate network 108. In the context of the present network architecture 100, the networks 104, 106 may each take any form including, but not limited to, a LAN, a WAN such as the Internet, public switched telephone network (PSTN), internal telephone network, etc.

In use, the gateway 101 serves as an entrance point from the remote networks 102 to the proximate network 108. As such, the gateway 101 may function as a router, which is capable of directing a given packet of data that arrives at the gateway 101, and a switch, which furnishes the actual path in and out of the gateway 101 for a given packet.

Further included is at least one data server 114 coupled to the proximate network 108, which is accessible from the remote networks 102 via the gateway 101. It should be noted that the data server(s) 114 may include any type of computing device/groupware. Coupled to each data server 114 is a plurality of user devices 116. Such user devices 116 may include a desktop computer, laptop computer, handheld computer, printer, and/or any other type of logic-containing device. It should be noted that a user device III may also be directly coupled to any of the networks, in some embodiments.

A peripheral 120 or series of peripherals 120, e.g., facsimile machines, printers, scanners, hard disk drives, networked and/or local storage units or systems, etc, may be coupled to one or more of the networks 104, 106, 108. It should be noted that databases and/or additional components may be utilized with, or integrated into, any type of network element coupled to the networks 104, 106, 108. In the context of the present description, a network element may refer to any component of a network.

According to some approaches, methods, and systems described herein may be implemented with and/or on virtual systems and/or systems which emulate one or more other systems, such as a UNIX system which emulates an IBM z/OS environment, a UNIX system which virtually hosts a MICROSOFT WINDOWS environment, a MICROSOFT WINDOWS system which emulates an IBM z/OS environment, etc. This virtualization and/or emulation may be enhanced through the use of VMWARE software, in some embodiments.

In other examples, one or more networks 104, 106, 108, may represent a cluster of systems commonly referred to as a “cloud.” In cloud computing, shared resources, such as processing power, peripherals, software, data, servers, etc., are provided to any system in the cloud in an on-demand relationship, therefore allowing access and distribution of services across many computing systems. Cloud computing typically involves an Internet connection between the systems operating in the cloud, but other techniques of connecting the systems may also be used, as known in the art.

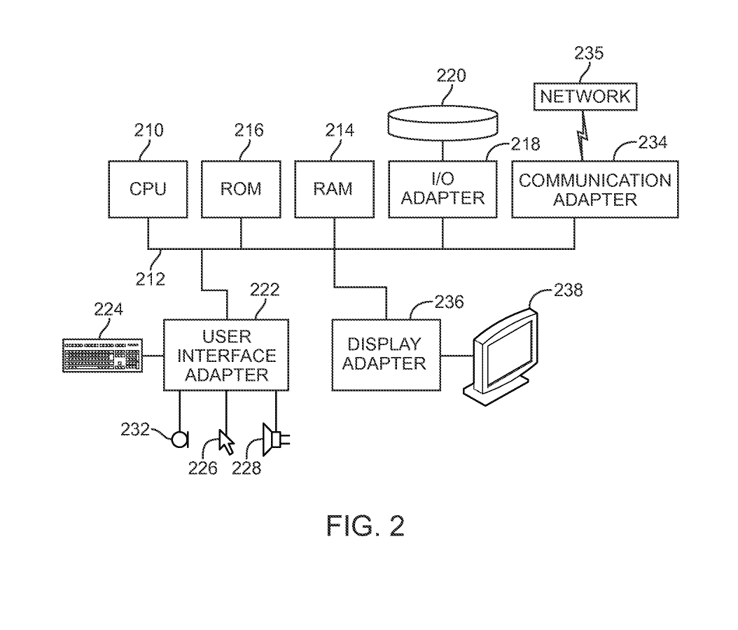

FIG. 2 shows a representative hardware environment associated with a user device 116 and/or server 114 of FIG. 1, in accordance with one embodiment. In one example, a hardware configuration includes a workstation having a central processing unit 210, such as a microprocessor, and a number of other units interconnected via a system bus 212. The workstation shown in FIG. 2 may include a Random Access Memory (RAM) 214, Read-Only Memory (ROM) 216, an I/O adapter 218 for connecting peripheral devices such as disk storage units 220 to the bus 212, a user interface adapter 222 for connecting a keyboard 224, a mouse 226, a speaker 228, a microphone 232, and/or other user interface devices such as a touch screen, a digital camera (not shown), etc., to the bus 212, communication adapter 234 for connecting the workstation to a communication network 235 (e.g., a data processing network), and a display adapter 236 for connecting the bus 212 to a display device 238.

In one example, the workstation may have resident thereon an operating system such as the MICROSOFT WINDOWS Operating System (OS), a MAC OS, a UNIX OS, etc. It will be appreciated that other examples may also be implemented on platforms and operating systems other than those mentioned. Such other examples may include operating systems written using JAVA, XML, C, and/or C++ language, or other programming languages, along with an object oriented programming methodology. Object oriented programming (OOP), which has become increasingly used to develop complex applications, may also be used.

According to an embodiment of the invention, PIM register message transmission control is provided in a system having a vLAG topology. One embodiment includes forwarding a communication packet to a first switch. A multicast source route entry is created by the first switch based on the communication packet. The communication packet is forwarded from the first switch to a second switch. A duplicate of the multicast source route entry is created by the second switch based on the forwarded communication packet. A register message is sent to a router by one of the first switch and the second switch based on vLAG primary and secondary roles. Sending of a duplicate of the register message by one of the first switch and the second switch is prevented.

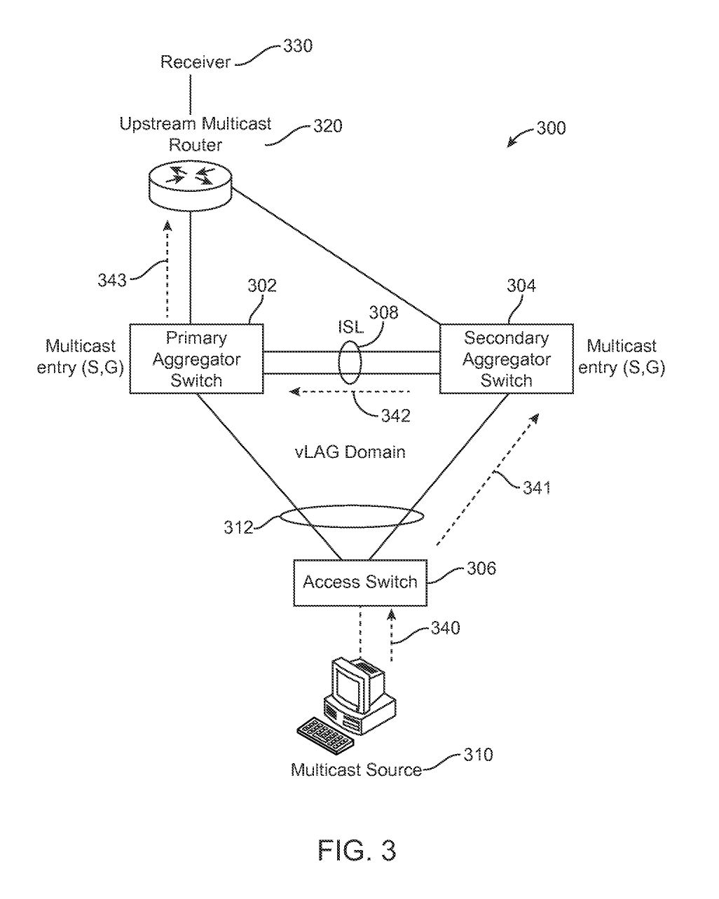

FIG. 3 is a diagram of an example data center system 300, in which an embodiment of the invention may be implemented. Each access switch 306 is connected to two aggregation switches for redundancy, for example, primary switch 302 and secondary switch 304. It should be noted that either switch 302 and 304 may be designated a role as the primary or secondary switch, VLAG is a feature that uses all available bandwidth without sacrificing redundancy and connectivity. Link aggregation is extended by vLAG across the switch boundary at the aggregation layer. Therefore, an access switch 306 has all uplinks in a LAG 312, while the aggregation switches 302, 304 cooperate with each other to maintain this vLAG. In one example, traffic 340 is forwarded from the multicast source 310 to the access switch 306. The access switch 306 forwards traffic 341 to the secondary aggregator switch 304, which in turn may forward the traffic 342 to the primary aggregator switch 302.

Since vLAG is an extension to standard link aggregation, layer 2 and layer 3 features may be supported on top of vLAG. In the system 300 shown in FIG, 3, both primary aggregator switch 302 and secondary aggregator switch 304 have PIM enabled. PIM uses a routing table to discover whether a multicast packet has arrived on the correct interface. The multicast source entries include (S, G) information, where S represents an Internet Protocol (IP) address of a source device, and G represents a group address.

In vLAG PIM topology with a multicast source 310 connected to the vLAG ports, when multicast traffic is received by primary aggregator (vLAG) switch 302 and the secondary aggregator (vLAG) switch 304, both the primary aggregator (vLAG) switch 302 and the secondary aggregator (vLAG) switch 304 will create the multicast route entry regardless of a DR/Non-DR interface. In conventional systems, both the primary aggregator (vLAG) switch 302 and the secondary aggregator (vLAG) switch 304 will send the register message to the upstream multicast (PIM-RP) router 320 because both vLAG switches will act as first hop routers for the received multicast traffic. This will make the upstream multicast router 320 forward duplicate multicast packets to the receiver(s) 330 in shared path tree. Additionally, the upstream multicast router 320 may receive unwanted register messages continuously from one of the vLAG switches.

In one embodiment, only the primary vLAG switch will send the register message to the upstream multicast router 320 regardless of DR/Non-DR, and the register message is prevented/controlled from being sent by the secondary vLAG switch. In one embodiment; upon receiving the multicast traffic 341, the secondary vLAG switch creates the multicast route entry as per the PIM protocol, but the secondary vLAG switch will not send a register message to the upstream multicast router 320. In one embodiment, when the primary vLAG switch is down/failed, the secondary vLAG switch will become the primary vLAG switch and will start to send the register message to the upstream multicast router 320. In one embodiment, advantages of this approach over the conventional systems includes preventing unnecessary register messages from being sent to the PIM-RP router (e.g., upstream multicast router 320); and no special communication is required between the primary vLAG switch, secondary vLAG switch and the PIM-RP router.

In this example embodiment, since both vLAG switches are first hop routers and do not have DR/Non-DR interfaces in the vLAG switches, both vLAG switches will create multicast route entries and instead of both vLAG switches trying to send the register message to the router 320 (e.g., PIM-RP router), to avoid duplicate register messages on the shared path and ensure PIM protocol compliance, only the primary vLAG switch is permitted to send a register message 343 to the router 320 (which in this example is the second vLAG switch (primary aggregator switch 302)). The first vLAG switch (i.e., secondary aggregator switch 304) is thus, not permitted to send a register message 343 to the router 320. In one embodiment, the control of forwarding the register message 343 transmission does not prohibit other traffic communications. Therefore, after the PIM topology settles, either the primary or secondary vLAG switch can send native multicast data traffic to the receiver based on shortest path tree. In one embodiment; in the case where the primary vLAG switch is down or failed, the secondary vLAG switch will become the primary vLAG switch and will send a register message 343 to the router 320. In one embodiment, the primary vLAG switch forwards traffic 343 to the upstream multicast router 320 for forwarding to at a receiver 330.

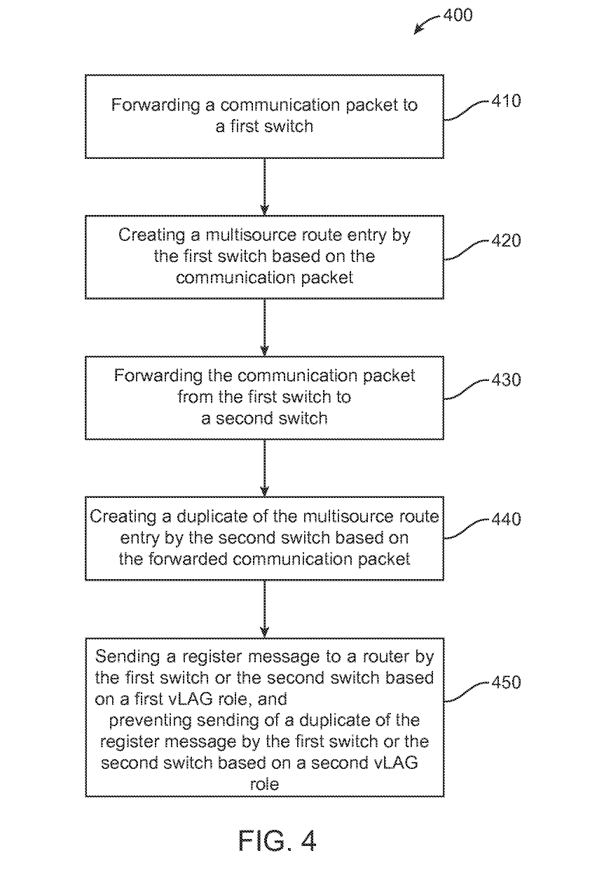

FIG. 4 shows a block diagram of a process 400 for PIM register message control, according to one embodiment. Process 400 may be performed in accordance with any of the environments depicted in FIGS. 1-3 among others, in various embodiments. Each of the blocks 410-450 of process 500 may be performed by any suitable component of the operating environment. In one example, process 400 may be partially or entirely performed by an aggregator switch, an access switch, a PIM module, etc.

As shown in FIG. 4, in process block 410, a communication packet (e.g., traffic including a multicast communication packet) is forwarded to a first switch (e.g., a primary or secondary vLAG switch). In block 420, a multicast source route/source entry is created by the first switch based on the forwarded communication packet. In one embodiment, in block 430, the communication packet is forwarded from the first switch to a second switch (e.g., over the ISL 308, FIG. 3). In block 440, the multicast source route entry is created by the second switch based on the forwarded communication packet. In one example, PIM is enabled on both the first and second switch in process 400. In block 450 a register message (e.g., register message 343, FIG. 3) is sent to a router (e.g., upstream multicast router 320, FIG. 3) by either the first switch or the second switch based on a first vLAG role (e.g., vLAG primary role). Sending of a duplicate of the register message by the first switch or the second switch is prevented based on a second vLAG role (e.g., a vLAG secondary role).

In one embodiment, in process 400, the first switch and the second switch are part of a vLAG topology, and the communication packet is forwarded to the first switch based on LAG hashing. In one embodiment, in process 400, the second switch forwards communication traffic to a multicast router (e.g., multicast router 320, FIG. 3) for forwarding to a receiver (e.g., receiver 330). In one embodiment, process 400 may provide for multicast source route entry synchronization to the first switch and the second switch for traffic forwarding regardless of DR or non-DR processing for the first switch and the second switch.

In one embodiment, for process 400 the first switch or the second switch is a primary vLAG switch, and if the second switch fails, the first switch becomes the primary vLAG switch In one example embodiment, the first switch and the second switch each comprise a first hop router.

According to various embodiments, the process 400 may be performed by a system, computer, or some other device capable of executing commands, logic, etc., as would be understood by one of skill in the art upon reading the present descriptions.

According to the embodiments and approaches described herein, unnecessary register messages sent to a PIM-RP are prevented, and no special communication is required between the vLAG Primary switch, secondary switch and the PIM-RP router.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in. any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The descriptions of the various embodiments of the present invention have been presented for purposes of illustration, but are not intended to be exhaustive or limited to the embodiments disclosed.

Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
forwarding a communication packet to a first switch;
creating a multicast source route entry by the first switch based on the communication packet;
forwarding the communication packet from the first switch to a second switch;
creating a duplicate of the multicast source route entry by the second switch based on the forwarded communication packet; and
sending a register message to a router by one of the first switch and the second switch based on a first virtual link aggregation group (vLAG) role, and preventing sending of a duplicate of the register message by one of the first switch and the second switch based on a second vLAG role.

2. The method of claim 1, further comprising enabling protocol independent multicast (PIM) on the first switch and the second switch.

3. The method of claim 2, wherein the first switch and the second switch are part of a vLAG topology, wherein the communication packet is forwarded to the first switch based on link aggregation group (LAG) hashing.

4. The method of claim 3, wherein the first switch forwards the communication packet over an inter-switch link (ISL), and the first vLAG role is a primary vLAG role, and the second vLAG role is a secondary vLAG role.

5. The method of claim 4, wherein the first switch and the second switch each comprise a first hop router.

6. The method of claim 5, wherein multicast source route entry synchronization is provided to the first switch and the second switch for traffic forwarding without designated router (DR) or non-DR interfaces.

7. The method of claim 3, wherein the second switch is a primary vLAG switch, and if the second switch fails, the first switch becomes the primary vLAG switch.

8. The method of claim 7, wherein the multicast source route entry information comprises (S, G) information, where S represents an Internet Protocol (IP) address of a source device, and G represents a group address.

9. A system, comprising:
an access switch that receives a communication packet from a multicast source;
a first virtual link aggregation group (vLAG) switch that receives the communication packet from the access switch and that extracts a multicast source route entry from the received communication packet;
a second vLAG switch that receives the communication packet from the first vLAG switch, extracts the multicast source route entry from the received communication packet,
wherein one of the first vLAG switch and the second vLAG switch sends a register message to a router based on vLAG roles, wherein one of the first vLAG switch and the second vLAG switch is prevented from sending a duplicate of the register message to the router based on a vLAG secondary role.

10. The system of claim 9, wherein protocol independent multicast (PIM) is enabled on the first vLAG switch and the second vLAG switch, wherein the communication packet is forwarded to the first vLAG switch based on LAG hashing, and the vLAG roles comprise a vLAG primary role and the vLAG secondary role.

11. The system of claim 10, wherein the first vLAG switch forwards the communication packet over an inter-switch link (ISL) to the second vLAG switch.

12. The system of claim 11, wherein each of the first vLAG switch and the second vLAG switch comprise a first hop traffic router.

13. The system of claim 12, wherein multicast source route entry synchronization occurs between the first vLAG switch and the second vLAG switch for traffic forwarding without designated router (DR) or non-DR interfaces.

14. The system of claim 11, wherein:
the second vLAG switch is designated as a primary vLAG switch;
if the second vLAG switch fails, the first vLAG switch becomes the primary vLAG switch; and
multicast source route entry information comprises (S, G) information, where S represents an Internet Protocol (IP) address of a source device, and G represents a group address.

15. A computer program product for register message transmission control over a link aggregation group (LAG), the computer program product comprising a computer readable storage medium having program instructions embodied therewith, wherein the computer readable storage medium is not a transitory signal per se, the program instructions executable by an access switch to cause the access switch to perform a method comprising:
forwarding, by the access switch, a communication packet to a first virtual link aggregation group (vLAG) switch;
creating, by the first vLAG switch, a multicast source route entry based on the communication packet;
forwarding, by the first vLAG switch, the communication packet to a second vLAG switch;
creating, by the second vLAG switch, a duplicate of the multicast source route entry based on the forwarded communication packet; and
sending a register message to a router by one of the first vLAG switch and the second vLAG switch based on vLAG roles, and preventing sending of a duplicate of the register message by one of the first vLAG switch and the second vLAG switch based on a vLAG secondary role.

16. The computer program product of claim 15, wherein the method further comprises enabling protocol independent multicast (PIM) on the first switch and the second switch, wherein the first vLAG switch forwards the communication packet over an inter-switch link (ISL) to the second vLAG switch, and the vLAG roles comprise a vLAG primary role and the vLAG secondary role.

17. The computer program product of claim 16, wherein the first vLAG switch and the second vLAG switch each comprise a first hop traffic router.

18. The computer program product of claim 16, wherein multicast source route entry synchronization is provided to the first vLAG switch and the second vLAG switch for traffic forwarding without designated router (DR) or non-DR interfaces.

19. The computer program product of claim 16, wherein the communication packet is forwarded to the first vLAG switch from the access switch based on LAG hashing, and the second vLAG switch is a primary vLAG switch, wherein if the second vLAG switch fails, the first vLAG switch becomes the primary vLAG switch.

20. The computer program product of claim 19, wherein multicast source route entry information comprises (S, G) information, where S represents an Internet Protocol (IP) address of a source device, and G represents a group address.
